(19) United States
(12) Patent Application Publication
(10) Pub. No.: US 2019/0136439 A1
(43) Pub. Date: May 9, 2019

(54) PROVISION OF LAUNDRY PRODUCT

(71) Applicant: Conopco, Inc., d/b/a UNILEVER, Englewood Cliffs, NJ (US)

(72) Inventors: Deborah Jane COOKE, Chester (GB); David MOORFIELD, Buckley (GB); Katharine Jane SHAW, Bebington, Wirral (GB)

(73) Assignee: Conopco, Inc., d/b/a UNILEVER, Englewood Cliffs, NJ (US)

(21) Appl. No.: 16/306,067

(22) PCT Filed: Jun. 1, 2017
(86) PCT No.: PCT/EP2017/063405

§ 371 Date: Nov. 30, 2018

(30) Foreign Application Priority Data
Jun. 9, 2016 (EP) 16173793.7

(51) Int. Cl. D06F 39/02; D06F 33/02; D06F 39/00; C11D 11/00; C11D 17/04; C11D 3/04; C11D 3/08; C11D 3/10; C11D 3/30; C11D 3/386; C11D 3/39

(52) U.S. Cl. CPC D06F 39/022; D06F 33/02; D06F 39/003; D06F 39/005; C11D 11/0017; C11D 17/041; D06F 39/024; C11D 3/08; C11D 3/10; C11D 3/30; C11D 3/386; C11D 3/39; D06F 2204/02; C11D 3/044

(57) ABSTRACT

The invention relates to methods for providing laundry product and a device (1) for dispensing laundry product according to a recipe. The laundry product is dispensed as a result of input by the user. The device has reservoirs (17a, 17b, 17c) containing different laundry product components which are dispensed according to input from the user. The device (1) may be integral to a washing machine (10) or stand-alone.

The present invention relates to methods and devices for providing laundry compositions on demand, for example in a user's home.

For many consumers, no one laundry product fulfils all of their needs. As a result, many consumers buy and store more than one laundry product. Selections include biological and non-biological products, products specifically formulated for white or colours or wools/silk. In addition to storing these laundry products, consumers often store one or more additional stain removal products and/or benefit agents. In total, this can amount to a relatively large number of bottles/boxes stored in consumers' kitchens, utility rooms, garages or basements. This also requires users to know which product is suitable for each load, and to understand and appreciate when and which additional stain removal products and/or benefit agents should be used.

Other consumers simply use one laundry product for all loads, regardless of suitability. This can mean that unnecessary enzymes, bleaches etc are used in so-called refresh washes (where the load is not stained) which may have detrimental effects on fabric care and/or the environment.

The present invention seeks to address one or more of these problems identified in the prior art.

### SUMMARY

The invention relates to a method and a device for dispensing laundry product according to a recipe. The recipe is selected based on the user's needs/preferences. The laundry product is prepared from reservoirs in the device. The reservoirs contain laundry ingredient compositions, which may be liquid or solid (e.g. powder). Mixtures of liquid and solid may be combined.

It is often difficult for consumers to know which laundry product or combination of laundry products is best suited to their needs for any wash. This can make doing the laundry seem intimidating, and can lead to poor wash performance when users select a less than optimal product, or waste and excessive fabric wear when consumers simply always select the same high performance product, regardless of the wash load type. In extreme cases, favourite items of clothing can be ruined.

The invention addresses these problems through the provision of a “smart” laundry product dispensing device that provides laundry product based on input about the load.

The device of the present invention has reservoirs which house a laundry ingredient composition, and the final product may be a mixture of these, determined according to the input provided. Input may relate to extent and/or type of staining, for example.

In other words, the device provides, on command, a composition from the first reservoir and optionally one or more of the further reservoirs, thereby providing a laundry product that may be considered bespoke to the user's particular wants and needs. In other words, the laundry product may be considered appropriate, or optimised for the purpose. For example, the product may be prepared to target particular stains, obviating the need for specific spot treatment.

An additional or alternative benefit of the present invention is that laundry product ingredient combinations not normally accessible in a single product may be generated by the device. As the time period between dosing the product and beginning the wash is small, problems associated with ingredient incompatibility and degradation are avoided.

This is especially true of liquid compositions, in which ingredients are more readily able to react on storage. Similarly, as composition is dosed directly into the dosing unit to a recipe stored within or generated by the device, it is not necessary that the final composition be substantially homogenous or of a particular viscosity, as is normally the case for commercially supplied laundry liquid products. This permits greater flexibility in the identity of, and relative ratios of, various ingredients.

In a first aspect, the invention relates to a method for providing laundry product bespoke to a wash load based on at least two criteria. Suitably the criteria relate to stain identity and load type (fabric type and/or colour). The method uses a device comprising a computer module and reservoirs containing various compositions that are combined based on the criteria selected.

Accordingly, in a first aspect the invention provides method for providing laundry product bespoke to a wash load using a device comprising a computer module which is configured to receive input concerning a laundry load based on one or more of the following criteria:
(i) stain identity;
(ii) fabric type and/or colour;
(iii) user requirements; and
(iv) user preferences;
   and reservoirs containing various compositions, the method comprising the steps of:
(a) providing input about stains present in the wash load to the computer module and
(b) providing input about the wash load fabric type and/or colour; and then causing the device to determine, based on said information, a recipe for laundry product which is optimised with respect to said input and composed of one or more compositions of the reservoirs, such that the device dispenses from one or more reservoirs to provide said laundry product.

It will be appreciated that step (a) may precede step (b) or may follow step (b).

In a further aspect, the invention relates to a device for providing laundry product bespoke to a wash load based on user input. It is optimised to balance wash performance with considerations that may include reducing waste, expense and fabric wear. The apparatus comprises a dispensing device having reservoirs containing various ingredients that are combined based on the user's input.

Accordingly, the present invention may provide a device for supplying a dose of laundry product, the device having a first reservoir containing a detergent composition and at least one further reservoir containing an ingredient composition, and a computer module which is configured to receive input concerning a laundry load based on one or more of the following criteria:
(i) stain identity;
(ii) fabric type and/or colour;
(iii) user requirements; and
(iv) user preferences;

wherein the computer module is programmed to determine, using the input criteria, a recipe for laundry product which is optimised with respect to said input and is composed of one or more compositions of the reservoirs, and then cause the device to dispense from one or more reservoirs to provide said laundry product.

The device may be termed a dispensing device. Compositions of reservoirs may be termed ingredient compositions. Compositions of reservoirs may be combined to provide laundry product and/or wash liquor.

Preferably, the computer module is configured to receive input concerning a laundry load based on at least two criteria selected from (i) to (iv) and to determine using the input criteria an optimised recipe which is dispensed.

(i) Stain Identity

Preferably, the computer module is configured to receive and use input based on stain identity. For example, the computer module may receive input via a user interface which provides a list of stains from which the user is prompted to select one or more stains.

To assist the user, the user interface may have a filter function, for example to group stains by, for example, category or colour. The user interface may also display recently selected stains (for example, the last 5 or 10 from previous uses) or most frequently selected over the device's history.

Stain categories may include, for example, Food and Drink, Play and Outdoor, Baby and Body, etc. Each category may then be divided into subcategories such as “Fruit and Veg”, “Oils and Fats” etc. In other words, the stain selection may be presented as a second filterable list within a first filterable list.

(ii) Fabric Type and Colour

One criteria used may be fabric colour (e.g. whites, lights, coloureds or mixed) and/or type. (e.g. cotton, polycotton, polyester). For example, the user interface may prompt the user to make selections from one or more lists based on these criteria.

As a result, the computer module may determine that a bleach/whitening ingredient composition should be added to the laundry product (for whites) or that minimal or no bleach ingredient composition should be added in the case of a coloured wash.

(iii) User Requirements

Optionally, a user may input certain requirements. These must be accommodated by the device in determining the laundry recipe. An example of a user requirement is “do not include a certain ingredient in this wash”, for example because a family member has an intolerance (for example, suffers skin irritation). In other words, user requirements are treated as hard constraints.

(iv) User Preferences

Optionally, a user may input certain preferences. These may be accommodated by the device in determining the laundry recipe, balanced against cleaning performance and other selections. For example, perfume may be provided in a reservoir, such that the device comprises a reservoir containing a perfumed composition. A user may select “not perfumed” or “perfumed”. In other words, user preferences are treated as soft constraints.

To further minimise wasted products, the computer module may be configured further to use load size data to determine the quantity of laundry product dispensed. This information may be input by a user or, in the case of device integral to a washing machine, obtained by the machine itself. In methods of the invention, the method may include a step of determining the weight of the load to be laundered and/or providing information regarding load size (for example, the user may classify the load as small, medium or large, either by weighing the load or by eye).

In each case, each reservoir suitably may contain a stock of the composition, such that multiple doses of laundry product may be supplied by the device without the need to refill the reservoirs. For example, each reservoir may be sized to house at least 5 doses of the composition, for example, at least 10, at least 15. In some cases, it is about 20. It will be appreciated that different reservoirs may provide different numbers of doses and reservoirs may be different sizes.

The computer module of the device may detect the amount of each composition in each reservoir to inform the user the further supplies should be ordered/initiate an automatic reorder via the internet or similar (for example, when a pre-determined number of washes remains).

The dispensing device may be located in a washing machine, such that ingredient compositions are dispensed directly into the water flow to form a wash liquor or into a chamber or pipe through which water subsequently flows.

In other words, the invention may provide a washing machine comprising a first reservoir containing a detergent composition and at least one further reservoir containing an ingredient composition, and a computer module which is configured to receive input concerning a laundry load based on one or more of the following criteria:
(i) stain identity;
(ii) fabric type and colour;
(iii) user requirements; and
(iv) user preferences;

wherein the computer module is programmed to determine, using the input criteria, a recipe for optimised laundry product composed of one or more compositions of the reservoirs, and then cause the device to dispense from one or more reservoirs to provide said laundry product.

The dispensing device may be suitable for placing on a countertop or building into a kitchen unit. In other words, it may be self-contained. This is also referred to herein as standalone. It may be supplied with a dosing unit. The dosing unit may be conventional dosing ball, or may have one or more features designed to complement or otherwise interact with the device. In some cases, the dosing unit seals the product within a chamber inside the unit, opening during the wash cycle to form a wash liquor.

The composition is dispensed by the computer module according to input provided. Input is provided before the wash cycle begins (in other words, before a wash liquor is formed). Input may be provided in various ways, for example by the user making choices or providing suggestions, or through sensing a tag or label in the article to be laundered (such as a QR “quick response” code). In the case of a device integral to a washing machine, the washing machine may obtain data without the need for an action by the user (for example, weighing or scanning a load). Preferably, input is provided by the user via a user interface.

Suitably, this input is captured via a user interface on the device or in electronic communication with the device. The device may include a graphical user interface (GUI). For example, the GUI may be presented to the user on a digital screen of the user interface. Input from the user may be captured by the user interface of the device via various user interaction mechanisms including: manipulation of buttons, touch screen, voice commands, gestures or other suitable methods. The computer module may communicate with an external user device such as a mobile phone, tablet or laptop to receive user inputs from a user interface on the external device. The interface may be part of a washing machine program selection. Using the interface, the user may select a suitable laundry product recipe, or the computer module may select, generate or obtain a recipe based on the input (load type, staining, preferences and previous wash history etc). The recipe used to determine the amounts may be obtained from an internal memory within the device, or may be obtained from an external memory accessed, for example, via the internet. Accordingly, in some embodiments, the user provides input via a GUI.

The user interface suitably includes a facility to input data in sets, for example through asking to user to select certain options or alternatives. The device may have or communicate with a user interface via which the user is able to input data using at least two sets of options. At least one set of options may prompt the user to input stain identity (grass, chocolate, blood etc).

Based on the data provided for a set or each of these sets, an algorithm may be employed to determine an optimised formulation, balancing the cleaning needs of certain stains or other factors against others. The algorithm may be stored and accessed on the computer module of the device, or it may be obtained from an external source such as the internet.

Accordingly, in some cases the computer module is programmed with an algorithm to determine how much product is dosed from each reservoir based on the user input.

Accordingly, in some cases the computer module is programmed to communicate with an external source to access an algorithm and determine how much product is dosed from each reservoir based on the user input.

Each reservoir is in controllable fluid communication with a dispensing nozzle which dispenses into the wash liquor or dosing unit. The compositions from the various reservoirs may be dispensed directly into the wash liquor or dosing unit (as it is not necessary that the various compositions are mixed before use) or may be dispensed via a pre-mixing chamber, which mixes two or more compositions prior to dispensing.

In some cases, the compositions are dispensed directly into a washing machine, the wash liquor or into a dosing unit. For example, the device may be integral to a washing machine such that compositions are dispensed to form a wash liquor during a wash program. For example, the device may be a standalone device such that compositions are dispensed into a dosing unit. The dosing unit may be placed in the washing machine drum, or the composition may be added a washing machine drawer.

Compositions may be dosed sequentially or concurrently.

In some cases, the device has a pre-mixing chamber in which two or more compositions may be mixed prior to dispensing. Individual ingredient compositions may be dispensed into said chamber, where they may be mechanically mixed (by stirring or agitation, for example), or may naturally disperse and mix as each component is added.

The reservoirs may be integral to the housing of the device or, more preferably, they may be provided as pre-filled cartridges that cooperate with the housing of the device, such that the composition in the reservoir is in controllable fluid communication with a nozzle for dispensing the composition into the dosing unit, wash liquor of a machine or a pre-mixing chamber.

A reservoir cartridge may have stiff walls. In other words, the cartridge may retain its shape regardless of the amount of laundry product in the reservoir. A reservoir cartridge may have flexible walls. It will be appreciated that the cartridge may be configured to suit the overall design and shape of the device. Said reservoir cartridge may be, without limitation, a pouch or stiff plastic container.

Each reservoir cartridge may be fixable within the device such that the contents of the reservoir are sealable by a valve. Suitably, therefore, the cartridge comprises mating means configured to engage with complementary mating means on the device such that, when in place, the reservoir cartridge is held securely and laundry product within the reservoir cartridge is contained or released according to whether the valve of the device is in a closed or open state. In other words, the cartridge may comprise a connecting portion which mates with a complementary connection portion of the device.

Additionally or alternatively, the contents of the reservoir may be supplied by pressure and/or vacuum generated within the device. It will be appreciated that the device may have a pump to move the compositions from the reservoirs to the dosing nozzle, optionally via a pre-mixing chamber, to be dispensed.

Accordingly, each reservoir cartridge may be fixable to the device by mating means configured to engage with complementary mating means on the device such that, when in place, the reservoir cartridge is held securely and laundry product within the reservoir cartridge is contained or released according to whether the pump is on or off.

In a further aspect, the invention provides a reservoir cartridge comprising a composition as described here. The cartridge is fixable to the device such that the content of the cartridge is in controllable fluid communication with a device as described herein.

Embodiments of the invention may also provide a kit for a user to formulate bespoke doses of laundry product, wherein the kit includes a combination of reservoirs providing segregated stocks of laundry product components as described herein, optionally together with directions for combining selected portions of stock components in order to provide various alternative options for a dose of laundry product. A kit may optionally include a dosing unit for accommodating a dose of laundry product to be supplied to a washing machine, suitably by placing a dosing unit in a washing machine drum.

The present invention further provides methods of using a device as described herein to dispense a laundry product, the method comprising providing input to a computer module.

The present invention further provides methods of doing laundry using a device as described herein.

The method may comprise providing input to the computer module; then dispensing laundry product into a dosing unit; then introducing said laundry product into a washing machine; then starting a washing machine program.

Where the device is integral to the washing machine, the method may comprise providing input to the computer module then starting a washing machine program.

### DESCRIPTION

The invention will now be described without limitation with reference to the following diagrammatical drawings in which:

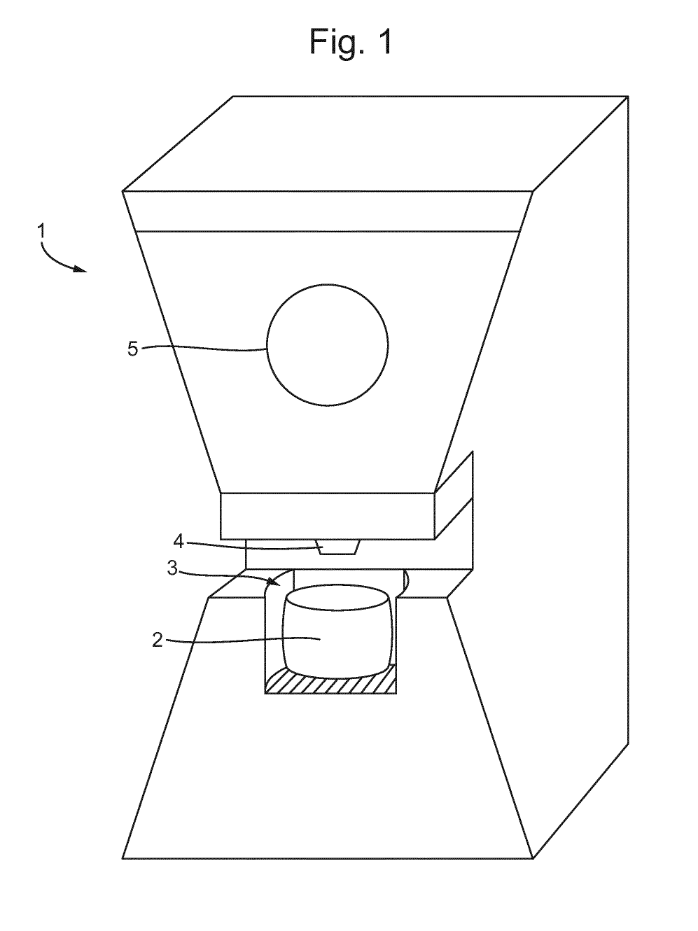

FIG. 1 shows a representative drawing of a device of the invention.

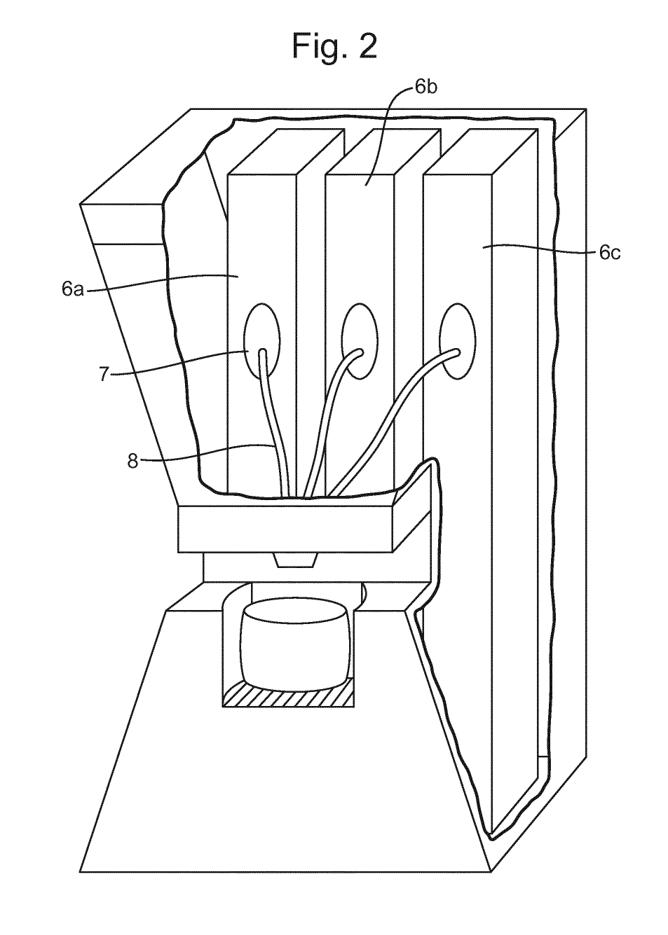

FIG. 2 shows a partially cut away representative drawing of the apparatus of the invention showing part of the cartridge arrangement.

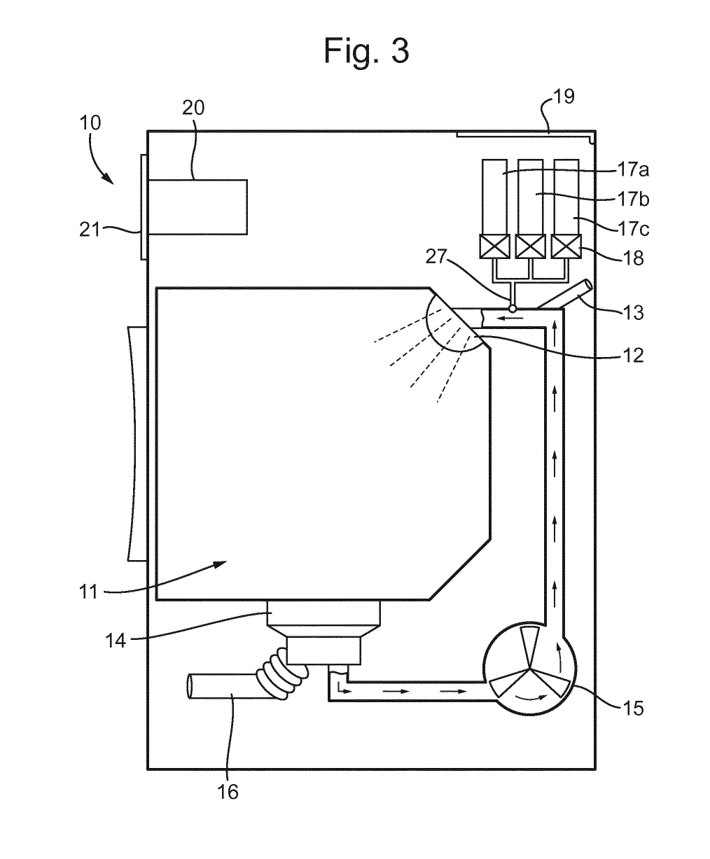

FIG. 3 shows a cross-section drawing of a device according to the present invention wherein the device is integral to a washing machine.

The apparatus as illustrated in FIG. 1 has a dispensing device 1 and a dosing unit 2. The apparatus shown is a standalone device, designed to be placed on a countertop or similar. For example, it may be placed on a countertop in a kitchen or utility room, or may be placed on top of a washing machine. However, it will be appreciated that the device may also be integral to a washing machine as described elsewhere.

As illustrated, the dosing unit is a conventional dosing ball, which is typically made of plastics material. In use, the dosing unit is placed in a dispensing area 3 located underneath a nozzle 4. As illustrated, the dispensing area 3 is a recess provided in the device housing, and the dosing unit 2 is placed on a surface provided in the housing. However, it will be appreciated that the housing may be shaped in different ways such that, for example, the dosing unit is placed directly on the countertop (or other surface on which the device is placed) in use.

Laundry product ingredients are dispensed into the dosing unit 2 via the nozzle 4. As shown, only one nozzle is used. However, it will be appreciated that more than one nozzle may be provided. For example, different reservoirs may be in fluid communication with different nozzles such that a first reservoir is in fluid communication with a first nozzle and a second reservoir is in fluid communication with a second nozzle.

The device has a control/information interface 5. As illustrated, the interface 5 is a touch screen provided in the housing that both displays information and allows selections and information to be inputted to a computer module (not shown).

However, in other embodiments the device may be provided with a panel having buttons, dials or similar for inputting information. In other embodiments, input may be conveyed via command or gesture. It will be appreciated that a display screen in the housing of the device is not essential. The device may be configured for use without a display screen, or an external display screen on for example a phone or tablet may be coupled to the device (for example, via Bluetooth or similar).

FIG. 2 shows a partially cutaway image of the apparatus of FIG. 1. The interior houses three cartridges (6a, 6b, and 6c). It will be appreciated that the arrangement is representative. For example, the cartridges may be provided in a row, or maybe fixed containers into which a composition is poured to replenish.

Each cartridge houses an ingredient composition as described herein. Each cartridge has a valve 7. Each cartridge is in fluid communication with the nozzle via a flow path 8. Flow from the cartridge to the nozzle (where it is dispensed) is controlled by the valve. In this embodiment therefore each valve is a metering valve, with the volume metered controlled by the computer module. It will be appreciated that the valves may be located at any point along the flow path, and other types of valve may be used. It will also be appreciated that metering of the ingredient compositions may be achieved in other ways, for example through generation of pressure in the reservoir to force the composition out.

The diagram shows individual flows running from each reservoir to the nozzle 4. It will be appreciated that flow paths may meet before the nozzle is reached. For example, the device may have a pre-mixing chamber in which different ingredient compositions meet before they are dispensed into the dosing unit.

In use, the dosing unit is located under the nozzle (such that product dispensed through the nozzle enters a chamber of the doing device). The user inputs information about the laundry load to the computer module. Typically, data may be entered in in two or more sets, each set requiring certain information from the user. For example, Set I may be used to input the load type: whites or colours. Set II may be used to input the presence or absence of staining and, optionally, the stain type. The user may therefore select whites, grass stains, mud stains. Other data requirements may include the fabric type (cotton/polycotton/polyester) as optimal fabric care benefit agents and amounts may be different in each case; fragrance selection (different members of the household may prefer different fragrances for their clothing, or it may be desirable to fragrance bedding and towels but not clothes); extent of staining (for example, lots of grass stains, only light mud stains).

The optimised wash composition is then determined and the appropriate amount from relevant cartridges dispensed. The computer module (not shown) controls the amounts dispensed.

The recipe used to determine the amounts may be obtained from an internal memory within the device, or may be obtained from an external memory accessed, for example, via the internet. Often, particularly where there is more than one stain type, an algorithm may be employed to determine the optimised formulation, balancing the cleaning needs of certain stains against others.

As described herein, the device may be separate to a washing machine, for example on a countertop or built into kitchen units (so called, standalone), or may be integral to a washing machine. FIG. 3 illustrates an embodiment of the invention in which the device is integral to a washing machine 10. The washing machine has a drum area 11 in which articles are laundered. As is conventional, this houses a rotatable basket into which articles to be laundered are placed (not shown). During a wash program, water and wash liquor enter the drum via a sprayer 12. Water enters the machine via inlet 13 (schematically and only partially shown). Water and wash liquor drain from the drum area 11 into a sump 14 and may then recirculate via recirculating pump 15 (arrows indicate direction) to be resprayed into the drum area, or may be drained via waste outlet 16. The device has three reservoirs 17a, 17b, and 17c. As shown, these are cartridges that engage with dispensing means 18, although it will be appreciated that the reservoirs may be provided simply as containers into which compositions are poured. The cartridges may be loaded and changed through access flap 19.

The device has a computer module 20. As described herein the computer module controls which and optionally how much of each cartridge is dispensed. As shown here, the washing machine has a control panel 21 via which input may be provided to the computer module. As illustrated, the control panel is a touch screen. In the present case, the control panel and computer module are also the used to determine the machine program, although it will be appreciated that they may be separate.

As previously described, in use the user inputs information about the laundry load to the computer module 20. The optimised wash composition is then determined and the appropriate amount from relevant cartridges dispensed by dispensing means 18 and may be combined before entering the water flow of the machine, for example in a single pipe or chamber. This may be termed a pre-mixing area 27. As illustrated, three individual pipes combine to a single pipe, via which the product is dosed. In other words, the ingredient compositions dispensed may be at least partially premixed before being diluted to provide a wash liquor. The computer module controls the amounts dispensed.

The following representative compositions may be used. It will be appreciated that it is not essential that all of the following compositions are present in the device. Further compositions may be present.

(i) Composition Comprising a Surfactant

Also referred to as a detergent formulation/composition, this composition comprises one or more surfactants. Preferably, the composition does not contain an enzyme. Preferably, the composition does not contain a bleach. Optionally, the composition does not contain a sequestrant.

Example components for the detergent composition include the following:

Anionic surfactants, for example having an anion selected from linear alkyl benzene sulfonate (LAS), primary alkyl sulfate (PAS), alkyl ether sulfate (AES) and mixtures thereof.

Nonionic surfactants, for example which may include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used.

Amine Oxide Surfactants of formula R¹N(O)(CH₂R²)₂ in which R¹ is a long chain moiety and each CH₂R² is a short chain moiety. R² is preferably selected from hydrogen, methyl and —CH₂OH. In general R¹ is a primary or branched hydrocarbyl moiety which can be saturated or unsaturated, preferably, R¹ is a primary alkyl moiety having chain length of from about 8 to about 18 and R² is H. These amine oxides are illustrated by C₁₂₋₁₄ alkyldimethyl amine oxide, hexadecyl dimethylamine oxide, octadecylamine oxide.

Some zwitterionic surfactant, such as sulphobetaine, may be present. A preferred zwitterionic material is a betaine available from Huntsman under the name Empigen® BB.

Preferably the compositions contain less than 10 wt %, more preferably less than 5 wt % zwitterionic surfactant.

Cationic Surfactants may be included, but are preferably substantially absent from the detergent formulation.

A particularly preferred surfactant system is provided by linear alkyl benzene sulfonate (LAS) and C₁₀-C₁₅ alcohol ethoxylated nonionic surfactant with 2 to 7 EO.

(ii) and (iii) Compositions Comprising at Least One Enzyme

While enzymes are powerful stain removers, for many wash loads some or all enzymes may be omitted. For example, different families of enzymes are effective against different classes of stain, and a large number of laundry loads are not stained at all. Including enzymes in each and every wash may therefore be wasteful.

The inventors have observed that certain enzymes cannot be stored in combination. For example, protease and lipase cannot usually be combined in a single liquid composition because as the protease may digest the lipase on storage. Similarly, protease may digest cellulase on storage in a liquid. However, lipase gives excellent benefits on removal of fats, while cellulase gives improved fabric treatment with colour preservation and pill removal and/or background whiteness benefit (depending on the cellulase used). This means that conventional laundry projects often contain an enzyme mix.

The present invention permits, through use of more than one reservoir comprising an enzyme composition, the assorted benefits of these enzymes to be accessed in a single load.

For example, the device may comprise a reservoir (ii) containing a first composition comprising a protease and a further reservoir (iii) containing a second composition comprising a cellulase and/or a lipase. Neither, one or both of these compositions may then be supplied depending on, for example, the type of staining.

In some embodiments, the composition of reservoir (ii) comprises a protease. Suitably, the composition of reservoir (ii) does not contain a cellulase and/or a lipase. The composition of reservoir (ii) may optionally further comprise a pectate lyase.

The composition of reservoir (ii) may optionally further comprise a surfactant, for example, sodium laureth sulfate (SLES). This additional surfactant may be used to boost detergency over and about that of the detergent composition, which may be useful in the case of stained loads. Certain surfactants are also known to be more suited to enzymatic cleaning processes.

The device may dispense the composition of reservoir (ii) for stains such as grass and blood.

In some embodiments, the composition of reservoir (iii) comprises a cellulase and/or a lipase and/or an amylase. Preferably, the composition of reservoir (iii) comprises a lipase. Suitably, the composition of reservoir (iii) does not contain a protease.

In some cases, the composition of reservoir (iii) comprises a cellulase. In some cases, the composition of reservoir (iii) comprises a lipase.

In some cases, the composition of reservoir (iii) comprises an amylase.

Naturally, the composition of reservoir (iii) may comprise any combination of these enzymes.

The composition of reservoir (iii) may optionally further comprise a mannanase. The composition of reservoir (iii) may optionally further comprise a surfactant, for example SLES. As described for (ii), this additional surfactant may be used to boost detergency over and about that of the detergent composition, which may be useful in the case of stained loads.

The device may dispense the composition of reservoir (iii) for stains such as gravy, starch-based stains, chocolate and chocolate products, fatty cooking stains.

(iv) and (v) Compositions Comprising a Bleach Component and an Alkaline Component

Reservoirs of this type may be used in combination. In other words, the compositions may be dosed together, using the alkali to activate the bleach ready for, or during, a wash or a rinse process in order to provide an effective bleaching action.

These may be dispensed for tea, coffee, wine, and berry stains, as well as improving overall whiteness and providing hygiene benefits.

(iv) Composition Comprising a Bleach Component

Suitably, the composition comprising a bleach component (iv) has an in-reservoir pH equivalent to pH of 7 or less, while the composition comprising an alkali (v) is suitable for raising the pH wash liquor in order to initiate and/or promote action of the bleach component said wash liquor.

Preferably the composition containing the bleach component has an in-reservoir pH of 6 or less, and more preferably has a pH in a range of 3 to 5. If the composition is not aqueous based it may have a pH as described when measured on dilution of the liquid composition to 1% using demineralised water.

The composition comprising a bleach component may additionally contain detergent active components (e.g. surfactants) which are compatible with the bleach component, such as discussed below. The composition containing an alkali component (v) may also contain detergent active components.

The bleach component is a component suitable for use in a laundry process. Preferably the bleach component comprises an oxygen bleach system. Such bleach systems may be, for example, a peroxygen bleach or a peroxy-based or peroxy-generating system.

Mixtures of bleaches can also be used.

Preferably the bleach component is selected so as to be easy to handle and storable according to the requirements for the least hazardous class of organic peroxides. This allows the first composition to be safely transported to and stored in a domestic setting.

A preferred category of bleaches encompasses percarboxylic acid bleaching agents, salts thereof and precursors thereof, especially organic percarboxylic acids, salts thereof and precursors thereof, particularly aromatic percarboxylic acids and especially heteroaromatic peroxycarboxylic acids, salts and precursors thereof.

Particularly preferred embodiments employ 6-(phthalimido) peroxyhexanoic acid (PAP) and salts thereof. The peracid formula is shown below.

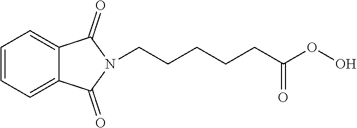 [SMILES: O=C(CCCCCN1C(=O)c2ccccc2C1=O)OO]

Peroxygen bleaches, perborates and percarbonate bleach components may optionally be combined with bleach activators which lead to the in situ production during the washing process of a peroxy acid corresponding to the bleach activator. If such a bleach component is in liquid composition, then a bleach activator will generally be provided in a different reservoir to the bleach component.

Examples of preferred peroxy acid bleach precursors or activators are TAED (N,N,N′N′-tetraacetyl ethylene diamine) and SNOBS (sodium nonanoyloxybenzene sulphonate).

Typically the composition may comprise up to 20 wt % of bleach component, especially up to 19 wt % and more preferably up to 18 wt %. Suitably the composition may comprise at least 2 wt % of bleach component, preferably at least 3 wt %, more preferably at least 4 wt % and especially at least 5 wt %.

In preferred embodiments, the composition contains additional fluorescent and/or whitener components such as shading dyes. Such additional components may be present preferably in amounts of from 0.005wt % up to 5 wt %, especially up to 2 wt % and more preferably up to 1 wt %.

Fluorescent agents may be supplied and used in the form of their alkali metal salts. The total amount of the fluorescent agent or agents used in the composition is generally from 0.005 to 5 wt %, preferably from 0.005 to 2 wt %, more preferably 0.01 to 0.5 wt %.

Preferred classes of fluorescent agent are: Di-styryl biphenyl compounds, e.g. Tinopal (Trade Mark) CBS-X and Tinopal CBS-CL, Di-amine stilbene di-sulphonic acid compounds, e.g. Tinopal DMS pure Xtra, Tinopal SBMGX, and Blankophor (Trade Mark) HRH, and Pyrazoline compounds, e.g. Blankophor SN.

Preferred fluorescent agents are: salts of: 2(4-styryl-3-sulfophenyl)-2H-napthol[1,2-d]triazole,; 4,4′-bis{[(4-anilino-6-(N methyl-N-2 hydroxyethyl)amino 1,3,5-triazin-2-yl)]amino}stilbene-2-2′disulfonate; 4,4′-bis{[(4-anilino-6-morpholino-1,3,5-triazin-2-yl)]amino} stilbene-2-2′-disulfonate; and 4,4′-bis(2-sulfostyryl)biphenyl.

Shading dyes may optionally be included. These may enhance the perception of whiteness. They may, for example, be violet or blue.

The composition of reservoir (iv) may optionally further comprise a surfactant, for example SLES. Once again, this may boost detergency over and above composition (i) alone in the presence of stains.

(v) Composition Comprising an Alkaline Component

pH adjustment may be effected with alkalinity sources such as, but not limited to: alkanolamines, such as monoethanolamine MEA, diethanolamine, and triethanolamine

TEA, and preferably MEA; alkali metal hydroxides, such as NaOH and KOH; alkali metal carbonates and bicarbonates such as sodium carbonate/bicarbonate and alkali metal silicates such as sodium silicate. Accordingly, the alkaline component may be one or more of these compounds.

The composition (v) may be up to 60 wt % in total of alkalinity components, more preferably up to 50 wt %, especially up to 40 wt %, even more preferably up to 30 wt %. For example, it may contain at least 15 wt % and preferably at least 20 wt %.

Optionally the composition has in-reservoir pH of at least 8, preferably at least 9, more preferably at least 10, especially at least 11, and most preferably at least 12. If the composition is not aqueous based it may have a pH in those ranges when measured on dilution of the liquid composition to 1% using demineralised water.

Preferably a dose of laundry product obtained from the combination of the compositions of reservoirs (iv) and (v), when diluted with 15 litres of water in a washing machine, is effective to provide a wash liquor having a pH of at least 6, preferably in a range of 7 to 11, more preferably in a range of 8 to 10, most preferably in a range of 8 to 9.5, and especially 8 to 9. Of course, different washing machine use different amount of water and dilution with greater amounts, for example 60 litres, is envisaged.

Preferably the composition contains components which function to buffer a wash liquor within a pH range of 7 to 11, more preferably 8 to 10 or to 9.5, especially 8 to 9.

The composition of reservoir (v) may include a builder. Suitable builders include inorganic materials (such as sodium citrate, sodium carbonate and sodium bicarbonate) and organic materials (such as polyacrylic acid, polymaleic acid and polyacrylic/polymaleic acid copolymers and salts thereof). The builder component(s) may be present in a total amount of from 5 wt % up to 50 wt % of the composition (v), more preferably up to 40 wt %, more preferably up to 30 wt %, especially up to 25 wt % and most preferably up to 20 wt %. The inventors believe that synergistic effects from a raised pH and lowered in-wash pCa or building enhance the detergency of both particulate and oily stains.

The composition of reservoir (v) may optionally further comprise a surfactant, for example SLES. Once again, this may boost detergency over and above composition (i) alone in the presence of stains.

(vi) Composition Comprising a Sequestrant;

The inventors have determined that the inclusion of a sixth reservoir comprising a sequestrant increases the flexibility of the device to deal with a variety of stains and garment types economically. Separating sequestrant from the composition of reservoir (i) may also permit greater flexibility of formulation of the composition of reservoir (i).

Sequestrant from reservoir (vi) may, for example, be dispensed to aid removal of bleachable stains on coloured garments, where use of a bleach may risk damage to the dye or fabric.

Suitably therefore, the composition of reservoir (vi) does not include a bleach.

Example sequestrants are HEDP (1-Hydroxyethylidene-1,1,-diphosphonic acid), for example sold as Dequest 2010, and (Diethylenetriamine penta(methylene phosphonic acid or Heptasodium DTPMP), Dequest® 2066. Preferably the composition contains up to 40% w/w of a suitable sequestrant system, including mixtures of different commercial sequestrants.

The following advantages are noted:

1. The recipe used is determined by input provided. In other words, it may be tailored to a particular wash. This means that active ingredients and benefit agents are dosed only as needed wanted, reducing waste and environmental impact. This may also improve the appearance and longevity of garments etc. Inefficient washes in which incorrect product is used leading to poor cleaning performance, necessitating additional washes, are avoided.

2. The user does not need to understand laundry product recommendations. The device of the present invention means anyone in the household can confidently do the laundry without worrying they don't understand the products available.

3. Each wash can be tailored to specific needs for different types and load and for different family members, including:
selective non-biological washes
hygiene washes for babies, pets and elderly family members
garment care refresh washes for adult work wear which may be delicate
tough stain removal for kids' clothes and sportswear
fragrance free washes according to preference.

4. In addition to “general” wash categories listed at point 2, each wash can be tailored to the specific type of stain(s), e.g. grass, beef fat, red wine.

5. Where input would normally lead to contradictory guidance from conventional products, the device of the present invention may balance the needs of one selection against another to achieve optimal cleaning across the load, for example by dosing a not optimum but suitable component for one stain to improve fabric care, or moderating the amount of a component dispensed.

6. Incompatible ingredients can be stored separately, and combined only in the wash liquor. Exemplary incompatible ingredient combinations are described herein.

7. Combinations of, and relative ratios of, ingredients can be used that are outside the normal limits of liquid laundry composition stability.

It is to be understood that the examples and embodiments described herein are for illustrative purposes and that various modifications or changes in light thereof will be suggested to a person skilled in the art and are included in the spirit and scope of the invention and the appended claims.

1. A method for providing laundry product bespoke to a wash load using a device comprising a computer module which is configured to receive input concerning a laundry load based on one or more of the following criteria:
(i) stain identity;
(ii) fabric type and/or colour;
(iii) user requirements; and
(iv) user preferences;
and reservoirs containing various compositions, the method comprising the steps of:
(a) providing input about stains present in the wash load to the computer module and
(b) providing input about the wash load fabric type and/or colour;
and then causing the device to determine, based on said information, a recipe for laundry product which is optimised with respect to said input and composed of one or more compositions of the reservoirs, such that the device dispenses from one or more reservoirs to provide said laundry product wherein the computer module is configured to receive input concerning a laundry load based on at least two of said criteria and wherein the computer module receives input via a user interface which provides a list of stains from which the user is prompted to select one or more stains and wherein the user interface has a filter function which filters the stain list by one or more of: category, colour, and frequently and recently selected.

2. A device for supplying a dose of laundry product, the device having a first reservoir containing a detergent composition and at least one further reservoir containing an ingredient composition, and a computer module which is configured to receive input concerning a laundry load based on one or more of the following criteria:
(i) stain identity;
(ii) fabric type and/or colour;
(iii) user requirements; and
(iv) user preferences;
wherein the computer module is programmed to determine, using the input criteria, a recipe for laundry product which is optimised with respect to said input and is composed of one or more compositions of the reservoirs, and then cause the device to dispense from one or more reservoirs to provide said laundry product wherein the computer module is configured to receive input concerning a laundry load based on at least two of said criteria and wherein the computer module receives input via a user interface which provides a list of stains from which the user is prompted to select one or more stains and wherein the user interface has a filter function which filters the stain list by one or more of: category, colour, and frequently and recently selected.

3. (canceled)

4. (canceled)

5. (canceled)

6. The method of claim 1 wherein the computer module is configured further to use load size data to determine the quantity of laundry product dispensed.

7. The method of claim 1 wherein each reservoir is a cartridge that cooperates with the housing of the device, such that the composition in the reservoir is in controllable fluid communication with a nozzle for dispensing the composition.

8. The method of claim 1 wherein the computer module is programmed with an algorithm to determine what is dispensed from each reservoir based on the input.

9. The method according to claim 1 wherein the computer module is programmed to communicate with an external source to access an algorithm and determine what is dispensed from each reservoir based on the input.

10. The method according to claim 1 wherein the device is a standalone device such that compositions are dispensed into a dosing unit.

11. The method according to claim 1 wherein the device is integral to a washing machine such that compositions are dispensed to form a wash liquor during a wash program.

12. A method of doing laundry, the method comprising:
(i) providing input to the computer module of the device of claim 2; then
(ii) dispensing laundry product into a dosing unit; then
(iii) introducing said laundry product into a washing machine; then
(iv) starting a washing machine program.

13. A method of doing laundry, the method comprising:
(i) providing input to the computer module of a device according to claim 2; then
(ii) starting a washing machine program.

14. The device of claim 2 wherein the computer module is configured further to use load size data to determine the quantity of laundry product dispensed.

15. The device of claim 2 wherein each reservoir is a cartridge that cooperates with the housing of the device, such that the composition in the reservoir is in controllable fluid communication with a nozzle for dispensing the composition.

16. The device of claim 2 wherein the computer module is programmed with an algorithm to determine what is dispensed from each reservoir based on the input.

17. The device of claim 2 wherein the computer module is programmed to communicate with an external source to access an algorithm and determine what is dispensed from each reservoir based on the input.

18. The device of claim 2 wherein the device is a standalone device such that compositions are dispensed into a dosing unit.

19. The device of claim 2 wherein the device is integral to a washing machine such that compositions are dispensed to form a wash liquor during a wash program.
